(19) United States
(12) Patent Application Publication
(10) Pub. No.: US 2024/0012134 A1
(43) Pub. Date: Jan. 11, 2024

(54) LOW-COST REAL-TIME MILLIMETER-WAVE IMAGING SYSTEM FOR SECURITY BODY SCREENING

(71) Applicant: Wenyi Shao, Laurel, MD (US)

(72) Inventor: Wenyi Shao, Laurel, MD (US)

(73) Assignee: EMAI LLC, Laurel, MD (US)

(21) Appl. No.: 18/372,061

(22) Filed: Sep. 23, 2023

(51) Int. Cl. G01S 13/88; G01S 7/35; G01S 13/89

(52) U.S. Cl. CPC G01S 13/887; G01S 7/356; G01S 13/89

(57) ABSTRACT

A modified back propagation (MBP) method designed to substantially enhance the computational speed of near-field microwave imaging and millimeter wave imaging. This method leverages two key factors to boost efficiency. Firstly, it employs path dimension reduction to diminish computational workload, accomplished by employing approximate path ranges. Rather than utilizing numerous highly precise path ranges to calculate phase shifts, this approach selects an appropriate range unit for approximate ranges, resulting in a significant reduction in computational workload with minimal impact on image quality. Secondly, it harnesses the power of an inverse fast Fourier transform along the frequency (wavenumber) dimension, representing frequencies as a minimum frequency plus increments. Through the combination of these two enhancements, the MBP method becomes applicable to real-time imaging systems, including but not limited to body security screening systems.

### BACKGROUND OF THE INVENTION

The present disclosure pertains generally to body screening for security, such as in airports and at the entrance of secure facilities, by using the millimeter (mm)-wave imaging technology.

Mm-wave body scanning technology has emerged as a cutting-edge solution in the field of security screening. This innovation employs non-ionizing electromagnetic waves in the mm-wave spectrum to detect concealed objects and threats safely and effectively on the human body. Unlike traditional X-ray methods, mm-wave scanners pose no health risks to individuals, making them ideal for widespread use in high-traffic locations such as airports, public events, and secure facilities. Mm-wave scanners have garnered considerable attention due to their ability to improve security screening efficiency without compromising safety or privacy. As a result, they have become an integral component of modern security systems, offering enhanced threat detection capabilities, and contributing to the safety and wellbeing of individuals in various public and secure environments.

The mm-wave body scanning technology operates on principle of detecting variations in the reflected mm-wave signals caused by objects on or beneath a person's clothing. Advanced algorithms and image reconstruction techniques are employed to generate detailed, privacy-preserving images that highlight potential security threats while safeguarding personal privacy. These algorithms and image reconstruction techniques can be broadly categorized into two classes:

The first heavily relies on the fast Fourier transform (FFT), employing a batch of three-dimensional (3D) FFT and inverse FFT (IFFT) operations. Its chief advantage lies in its ability to swiftly generate 3D images, approaching real-time performance, despite the processing of typically in the order of 10\hat{ }5 mm-wave signals. The pixels of the generated image by the FFT method represents the reflectance on the object surface. Currently, two common configurations are adopted by mm-wave body-scanner manufacturers: (1) a planar transmitter (Tx) array and a planar receiver (Rx) array, each comprising thousands of antenna elements, are systematically assembled in one plane. Mm-wave signals are then collected in a multi-static mode. This configuration holds the potential for real-time imaging. (2) a linear Tx antenna array and a linear Rx antenna rotate around the human body to form a 2D aperture. This setup avoids the use of dense array, requiring only a few hundred of antenna elements, thus saving the costs. However, the rotation of the linear array typical takes more than one second, rendering real-time imaging unfeasible. It is important to emphasize that both configurations necessitate even spacing between Txs and between Rxs or uniform rotation increments, in order to effectively leverage the FFT algorithm.

The second category employs a back propagation (BP) algorithm, also known as confocal or modified Kirchhoff migration (KM) algorithm. Pixels in the generated image by BP method stands for the focused energy by the algorithm, very different from the physis meaning of pixels generated by the FFT approach. The BP approach offers the flexibility of accommodating various array configurations, including unevenly sampled and highly sparse arrays. Furthermore, in contrast to the FFT approach, the BP method can produce images of any desired size or with any number of pixels without requiring interpolation (FFT necessitates interpolation in the K space). However, unlike FFT, which has been widespread used in mm-wave scanners produced by different manufactures, the BP approach suffers from inefficiency, often taking several hours to produce a whole-body image, even though a state-of-art graphics computing unit (GPU) is employed. Consequently, its practical incorporation into any real-world mm-wave screening device remains unlikely.

This patent aims to further advance and innovate in the field of mm-wave body scanning for security screening applications. In this invention, a sparse array, indicative of cost-efficiency, is equipped with a modified BP solver. The modified BP solver accelerates image reconstruction speeds by several thousands of times when compared to traditional BP methods. This transformation reduces the reconstruction time from hours to sub seconds, thus enabling the realization of a low-cost, real-time mm-wave imaging machine.

### SUMMARY OF THE INVENTION

The present inventive concepts belong to fast mm-wave imaging. The Mm-wave imaging is a cutting-edge technology that utilizes electromagnetic waves in the spectrum typically between several and 100 gigahertz (GHz), to create detailed images for like the human body for security and medical applications. Waves within this spectrum are non-ionizing, meaning they do not pose any known health risks to humans, making them suitable for widespread use in various applications.

In security applications, mm-wave body imaging has gained prominence in airports, border crossings, and other high-security locations due to its non-invasive nature and its capacity to detect concealed weapons, explosives, or contraband without requiring individuals to remove their clothing. At the core of mm-wave body imaging is the principle of reflection and scattering. When mm waves encounter an object or the human body, they interact with the various materials and structures they encounter. These interactions cause changes in the waves' phase and amplitude, which can be measured and analyzed to extract valuable information. Mm-wave body imaging is backscatter imaging. As a transmitter emits mm waves towards the subject being scanned, which can be a person or an object, these waves penetrate clothing and other non-metallic materials but are partially reflected by denser materials, such as metal objects or concealed threats like weapons or explosives. The reflected waves, or backscatter, are stronger than the reflection from skins. They are collected by an array of receivers strategically positioned to capture the returning signals. The collected backscattered signals are subjected to advanced signal processing and reconstruction algorithms. These algorithms analyze the changes in phase and/or amplitude of the received signals and transform them into two-dimensional (2D) or 3D images. These images reveal the profile of the body and the presence of hidden objects, providing security personnel with critical information for decision-making.

Nearly all existing manufacturers of mm-wave body scanners rely on FFT techniques to process the acquired mm-wave signal and generate images. This preference for FFT is primarily due to its remarkable efficiency, capable of producing 3D images swiftly, often within seconds or even fractions of a second. Such efficiency is a crucial factor, especially in bustling airports and other high-traffic travel hubs, where swift security screenings are paramount. Fast screening times translate to shorter lines and improved travel experiences. However, the utilization of FFT comes with certain constraints, primarily the requirement for a dense distribution of mm-wave signals across the sampling domain. Achieving this necessitates a dense antenna array, typically comprising thousands of Txs and thousands of Rxs, evenly spaced in a planar configuration. Regrettably, this approach is costly as the array's expense scales linearly with the number of antenna elements. Alternatively, a linear array with uniformly spaced elements along one dimension can be moved along the 2 nd dimension (or rotated in the case of cylindrical scanners) to form a 2D aperture. The increment along the 2 nd dimension must also be uniform. In comparison to the 2D-array strategy, utilizing a dynamic linear array can generate dense array signals with a reduced number of antenna elements, thereby reducing costs. However, this design is not conducive to real-time imaging, presenting a significant limitation.

The BP method, also referred to as the confocal algorithm or modified KM method, involves the calculation of the range between each focal point (representing an imaging point or the pixel within a 3D image) and each antenna (Tx and Rx). Subsequently, the mm-wave signals are phase shifted based on these range calculations and then aggregated. The computational time required for traditional BP is directly proportional to the number of focal points and the number of antennas. Given that mm-wave body scanners typically employ at least hundreds of antennas, and 3D mm-wave images may encompass tens of millions of pixels, traditional BP proves to be inefficient, rendering it unsuitable for integration into any existing mm-wave body screening products.

The low cost of the presented system lies in that it uses a very sparse antenna array, requiring much less number antennas than any existing similar device. This system is equipped with a modified BP algorithm, significantly enhancing computational efficiency (at least thousands of times faster) compared to the traditional BP approach. The acceleration primarily derives from using compressed number of ranges to calculate the pixels, and the use of iFFT along the sampling frequencies. This modified BP method can seamlessly integrated with a sparse array to deliver real-time mm-wave imaging, allowing for the development of a cost-effective and walk-through imaging device.

### BRIEF DESCRIPTION OF THE DRAWINGS

Embodiments will now be described in more detail with reference to the accompanying drawings, given only by way of example, in which,

FIG. 1 shows the general appearance of a cost-effective mm-wave body security scanner equipped with sparse antenna arrays. Optionally, two arrays can be utilized with one illuminating the front of the body and the other illuminating the back.

FIG. 2 is the deployment of the antennas, which form a 2D aperture in the horizontal and vertical direction.

FIG. 3 shows the mapping between signal paths and their range values.

FIG. 4 is a histogram showing the distribution of the range values as an example.

FIG. 5 shows a schematic of the mm-wave imaging system according to an embodiment of the invention.

FIG. 6 shows a generated front-view body image and a generated back-view body image by using the invented mm-wave imaging system according to an embodiment of the invention.

FIG. 7 illustrates the flowchart of the modified BP method for reconstructing mm-wave images in real time according to an embodiment of the inventive concepts disclosed herein.

### DETAILED DESCRIPTION OF EMBODIMENTS OF THE INVENTION

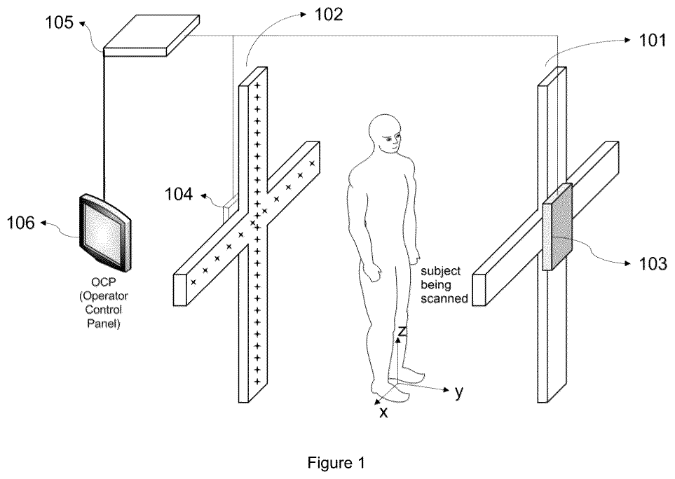

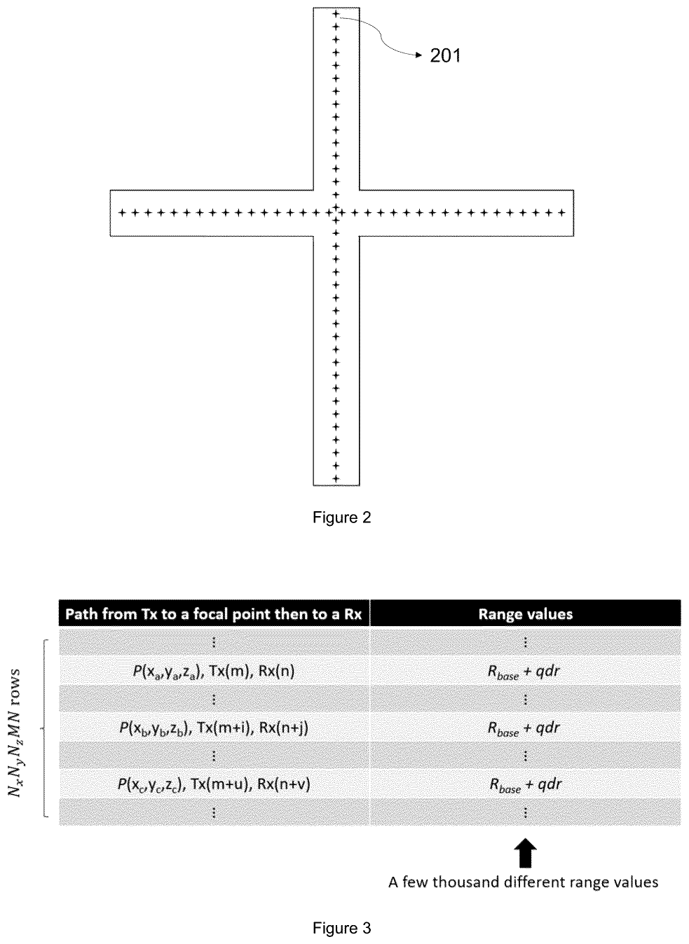

In accordance with the schematic shown in FIG. 1, the imaging device is composed of two antenna arrays 101 and 102, two advanced control units (ACU) denoted as 103 and 104, a data processing unit (DPU) 105, and an operator control panel (OCP) 106. A detailed description of each component is as following.

The arrays work in the multi-input multi-output (MIMO) mode. Each antenna array comprises at least one linear array along the horizontal direction, and at least one linear array along the vertical direction. A linear array comprises of multiple antenna elements 201. It is permissible for two perpendicular linear arrays not extending along the horizontal and vertical, but to form a planar array with two intersecting lines, such as in an “X” shape. The role of Tx and Rx can be configured in two ways:
(1) In the first mode, one line (and its parallel lines, if any) serves as the Rx array, while the other (and its parallel lines) perpendicular to the Rx array functions as the Tx array. At any given moment, only one Tx is transmitting signal, and at least one Rx within the Rx array is collecting the reflected signals.
(2) The second mode is a Tx-Rx combination array (full multi-static model): at a time only one antenna operates as a Tx, with all remaining antennas in the entire array serving as Rxs, until all antennas take turns as Txs. In this configuration, the array must be connected to a channel switcher to alternate the antenna's role.

The total number of antenna elements required in Mode (1) is supposed to be a few hundred, while Mode (2) can involve even fewer antennas. The fewer number of antenna elements may significantly reduce the cost of the overall system. It is worth noting that the spacing between antennas does not need to be uniform, as this sparse array employs a modified BP algorithm which will be presented in a late part of this section. The FFT approach cannot be applied to a scanner with such a sparse array.

The ACU is responsible for control each antenna's emission and reception timing. It is crucial that the ACU enables as many Rxs as possible to work simultaneously, which will significantly reduce the signal acquisition time and enhance overall efficiency. For example, assuming there are N Rxs in total, if N Rxs can work parallelly (simultaneously), each Tx only needs to transmit a signal once; If at one moment only N/2 Rxs can collect signals simultaneously, the collection will have to be formed by 2 groups and the same Tx will have to transmit the signal twice, leading to the overall acquisition time increased by twice. If Mode (2) is employed, the ACU will also incorporate a channel switcher. Therefore, while (2) can generate more signal channels with fewer antenna elements thus reduce antenna costs, the introduction of channel switchers represents an additional expense compared to Mode (1). Data acquisition is completed by the ACU before being transmitted to the DPU 105.

The DPU 105 is a central computing unit, typically a powerful computer 502 equipped with an advanced computational processing unit 501 like a graphics processing unit (GPU) or a field-programmable gate array (FPGA). The DPU is also responsible to execute the operation orders on 502 transmitted from the OCP 106, which is the interface between the human operator and the machine system. The DPU is also responsible to process the mm-wave signals delivered from the ACU to reconstruct the image. The incoming signals were collected by groups in sequence, where the number of groups is equal to the number of Txs. Each group of data represents the scattered signals obtained from all Rxs, activated by one Tx. Each group of data also include a frequency sweep from the lowest operation frequency fₘᵢₙ to highest operation frequency fₘₐₓ The fₘᵢₙ corresponds to the smallest wave number kₘᵢₙ and fₘₐₓ corresponds to the largest wave number kₘₐₓ. The relation between frequency and the wave number is

$$k = \frac{2 π f}{c} ,$$

where c is the speed of light in vacuum.

After receiving and storing all datasets in the DPU's memory, the DPU initiates the reconstruction of a 3D mm-wave image using the acquired data. Assuming M Txs, N Rxs, and an L-point discrete frequency sweep

$$( i . e . , L = \frac{{f}_{max} - {f}_{min}}{Δ f} + 1 ) ,$$

where Δf is the frequency step, fₘₐₓ−fₘᵢₙ is the frequency bandwidth. Hereafter, wave number will be used to denote sampling in the K space, corresponding to the frequency domain.

In the construction of a 3D image with dimensions Nₓ×N_{y}×N_{z} image, Nₓ, N_{y}, and N_{z} represent the number of focal points (or pixels) along the X, Y, and Z direction, respectively. In FIG. 1, assuming the system works in Mode 1, M Txs are in the vertical line and N Rxs are in the horizontal line. In traditional BP approach, the pixel value at position (x, y, z) in the 3D image is determined by summing over numerous mm-wave signals with phase compensation:

$$p ( x , y , z ) = {\sum }_{m = 1}^{M} {\sum }_{n = 1}^{N} {\sum }_{k = {k}_{min}}^{{k}_{max}} {S}_{m , n} {e}^{jk ( {r}_{m} + {r}_{n} )} herein ,$$

$${r}_{m} + {r}_{n} = \sqrt{{( x - {x}_{0} )}^{2} + {( y - {y}_{c} )}^{2} + {( z - {z}_{m} )}^{2}} + \sqrt{{( x - {x}_{n} )}^{2} + {( y - {y}_{c} )}^{2} + {( z - {z}_{c} )}^{2}}$$

where x₀=0, y_{c} and z_{c} are fixed constant as the system is set up. The coordinates of the transmitter and receiver are (x₀, y_{c}, zₘ) and (xₙ, y_{c}, z_{c}), respectively. k is the wave number of the scanning frequency. The number of Txs is M and the number of Rxs is N. S_{m,n} represents a signal corresponding to m^{th} Tx and n^{th} Rx at a certain frequency. This computational process is indeed time-consuming, with a traditionally complexity proportional to Nₓ×N_{y}·N_{z}·Nₖ·M·N, typically denoted as O(N⁶). A typical 3D image consists of tens of thousands of pixels (Nₓ×N_{y}·N_{z}), each requiring compensation for phase delay based on M·N path ranges. This level of computational complexity renders real-time imaging unfeasible.

To tackle this challenge, optimization of the BP method is necessary. The first approach in this invention to accelerate BP is by range counts reduction. As the transmitter and receiver remain fixed, and the pixel positions to be imaged are also constant, all paths and their corresponding range values remain the same regardless of the subject being scanned. Furthermore, each pixel's phase delay is essentially influenced by the path range rₘ+rₙ, and many different paths have very similar range values. Thus, using approximation range values for paths may significantly reduce the number of range values.

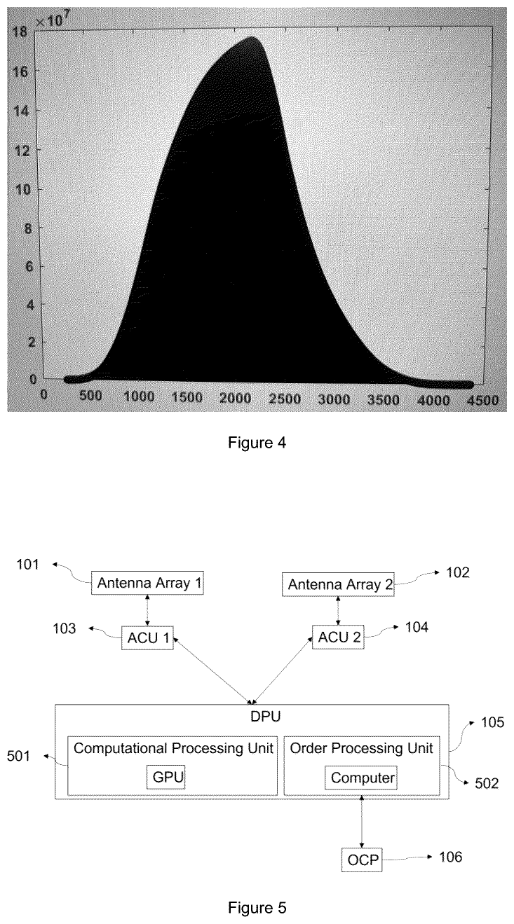

To make this clear, consider an example that a region to be imaged is a 0.94×0.94×1.88 meter block centered in origin in FIG. 1, which is meshed by Nₓ×N_{y}·N_{z}=256×256×512 grids. Assuming an array is placed 0.6 meter away from the origin (y=0.6 m, for simplicity, only consider use one of the two arrays to image one side of the body) and M=108 and N=72, there will be NₓN_{y}N_{z}MN (approximately 260 billion) paths. Among all the paths, the minimal range is 260 mm and the maximum is 4,359 mm. If a range unit (increment) is set as 1 mm, there will only be 4100 distinct range values in total. Under this unit set, FIG. 3 indicates that many paths share the same range values. FIG. 4 presents a histogram displaying the distribution of these 4100 distinct values, where the horizontal axis represents the 4100 range values (260˜4359) while the vertical axis represents the count of each range value. The distribution basically forms a bell-shaped curve, with the peak at 2,166 indicating that there are approximately 173 million paths with the same range value of 2,166 mm. Instead of using ˜260 billion accurate range values to calculate the phase compensation S_{m,n}e^{jk(r}^{ₘ}^{+r}^{ₙ}⁾, this invention uses 4100 approximate values to compensate M·N signals' phase, and then properly assigns the result back to each path. By using such a method equivalent to path reduction, it turns out that the overall computational time can be reduced from hours (as in traditional BP) to mere seconds.

In the previous example, the range unit was set as 1 mm, with decimals rounded to the nearest integer, resulting in a maximum error of 0.5 mm. This error is one twentieth of the wavelength at GHz and one tenth of the wavelength at 60 GHz. Such an error almost has not impact on image quality.

Furthermore, once the physics dimension of a scanning machine is established, the minimum and the maximum ranges can be determined. By selecting an appropriate increment, all range values between the minimum and maximum can be predefined. Using these predefined values, the phase shifts for all frequencies can be pre-calculated. This eliminates the need for computing path ranges and phase shifts from a Tx to a focal point, and then to a Rx for each future measurement. The pre-evaluated phase-shift values can be applied to compensate for the phase of measurement signals in all subsequent scans. Consequently, in future real measurements, phase-shift calculations based on path ranges, as required in traditional BP method, become unnecessary.

Let r_{base} represents the minimum range value and express all other ranges as r_{base}+q·dr, where dr is the increment (dr=1 mm as in the previous example), and q is an index (q=0˜4099 as in the previous example). The pixel value at position (x, y, z) in a 3D image can be rewritten as

$$p ( x , y , z ) = {\sum }_{m = 1}^{M} {\sum }_{n = 1}^{N} {\sum }_{k = {k}_{min}}^{{k}_{max}} {S}_{m , n} {e}^{j ( {k}_{min} + t \cdot dk ) ( {r}_{base} + q \cdot dr )}$$

where we have written k=kₘᵢₙ+t·dk and kₘᵢₙ is the minimum wavenumber of the scanned frequencies. t is the index of the scanned frequency, and

$$dk = \frac{2 π B}{{cN}_{f}}$$

is the wavenumber increment. B is bandwidth, c is the speed of light, and N_{f} is the number of frequency samples (actually N_{f}=Nₖ). dr is also a spatial resolution for differentiating all rₘ+rₙ cases. The selection of dr is a tradeoff between precision and computational workload. Herein, we record

$$dr = \frac{c}{δ B} ,$$

where δ is a parameter to control the selection of dr, i.e., a larger δ turns to a smaller increment dr. Thus, p(x, y, z) can be rewritten as

$$p ( x , y , z ) = {\sum }_{m = 1}^{M} {\sum }_{n = 1}^{N} {e}^{j ( {k}_{min} ( {r}_{base} + q \cdot dr )} \cdot {\sum }_{t = 1}^{{N}_{f}} {S}_{m , n} {e}^{j \frac{{r}_{base} t \cdot dk}{δ}} {e}^{jtq \frac{2 π}{{N}_{f}}} = {\sum }_{m = 1}^{M} {\sum }_{n = 1}^{N} {e}^{j ( {k}_{min} ( {r}_{base} + q \cdot dr )} \cdot IDFT ( {S}_{m , n} {e}^{j \frac{{r}_{base} t \cdot dk}{δ}} )$$

where IDFT refers to an inverse discrete Fourier transform of a phase shift

$$( {e}^{j \frac{{r}_{base} t \cdot dk}{δ}} )$$

of the measurement signal S_{m,n}. In practice, the IDFT can be substituted with the IFFT, representing the second acceleration introduced in this invention. It is projected that this second acceleration can further reduce the overall computational time, potentially from few seconds to the order of 10⁻¹ second or even less, thus rendering real-time imaging attainable.

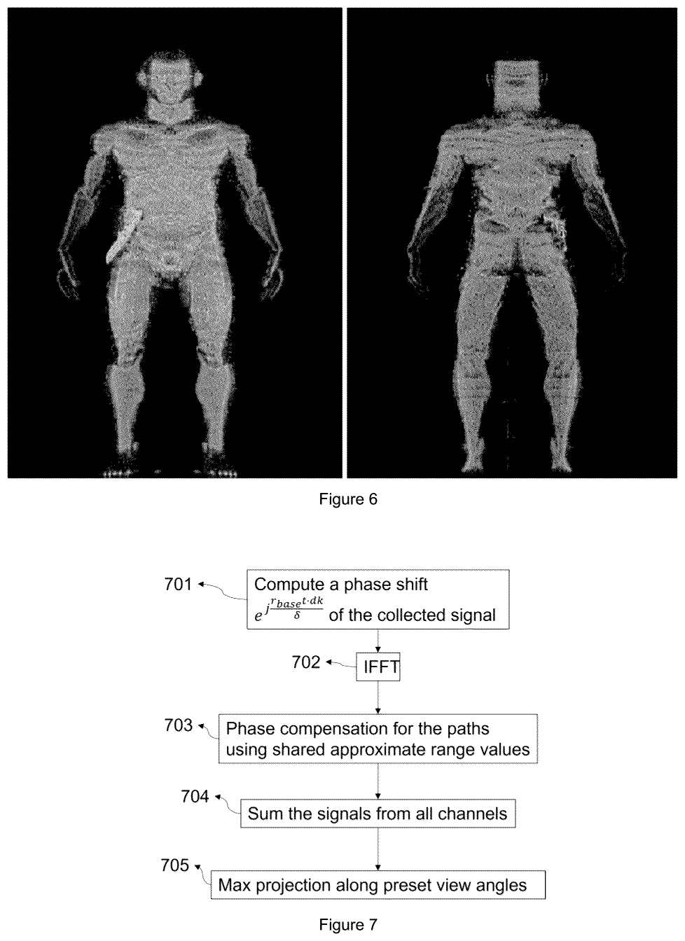

Once a 3D image is obtained, a maximum-projection computation can be executed along any chosen direction to achieve a 2D projection image. The operator has the flexibility to select one or multiple viewing angles through the OCP 106 to observe real-time 2D images on the OCP screen. FIG. 6 showcases two projection examples, representing the front and dorsal views of the body, respectively, utilizing the proposed array configuration and modified BP approach. FIG. 7 outlines a flowchart detailing the steps involved in reconstructing a mm-wave image using the proposed modified BP method. In step 701, mm-wave signals collected from the array are phase-shifted by multiplication with

$${e}^{j \frac{{r}_{base} t \cdot dk}{δ}} .$$

Step 702 involves computing the IFFT of the phase-shifted signals. In Step 703, phase compensation is applied to the paths at the lowest frequency (smallest wavenumber kₘᵢₙ) using shared approximate range values. Step 704 entails summed up signals from all channels, and the results can be directly used as pixels values or linearly converted to them. If necessary, the data can be reshaped to a 3D format. Finally, in Step 705, max projection is executed along the desired viewing angles, which can be pre-set in DPU and adjusted via the OCP 106 as needed.

The modified BP method described herein is not confined to the particular antenna array configurations presented. It is evident to those skilled in the art that alterations and adjustments can be implemented while remaining within the essence and extent of the inventive concepts.

We claim:

1. A near-field or mm-wave imaging system, comprising:
a sparse multi-input multi-output antenna array, which includes:
transmitters configured to emit a mm wave towards a subject or object;
receivers configured to capture mm wave signals from a subject or object;
a computation processor programmed to create real-time images of the object using a Modified Back Propagation (MBP) approach;
wherein, the MBP computation efficiently compensates for phase shifts across all signal paths, originating from each transmitter to each receiver via multiple focal points, within the operational frequency band.

2. The system of claim 1 wherein the sparse antenna array can comprise a transmitter array and a distinct receiver array.

3. The transmitter array and receiver array of claim 2 wherein each array is a linear array oriented orthogonally to the other linear array.

4. The system of claim 1 wherein the spacing between antenna elements in both the transmitter array and receiver array can be non-uniform.

5. The system of claim 1 further including a controller programmed to manage the timing of transmitters and receivers:
(1) Only one transmitter emits mm-wave signal at any given moment, while multiple receivers capture the backscattered mm-wave signal, and
(2) All transmitters sequentially transmit mm-wave signals in turns.

6. The system of claim 1 wherein each antenna element is capable of acting as a transmitter, while the remaining antenna elements operate as receivers.

7. The system of claim 1 wherein real-time image reconstruction using the MBP method is expedited through path dimension reduction and inverse fast Fourier transform along the frequency dimension.

8. AN MBP method for generating a mm-wave body image, accelerated through path dimension reduction, comprising:
transmitting a mm-wave signal from a transmitter toward a subject;
receiving the mm-wave signal from the subject using a receiver;
compensating the phase shifts in the propagation path using an approximation value of the path range; and
creating an image of the subject by utilizing the phase-shifted mm-wave signal.

9. The method of claim 8 wherein the minimum and the maximum path ranges are precomputed and need to be calculated only once.

10. The method of claim 8 wherein a minimum propagation path range is employed as a range base, and other ranges up to the maximum range are expressed as the range base plus one increment or multiple increments.

11. The method of claim 10 wherein the increment is chosen as a fraction of the speed light divided by the frequency bandwidth.

12. The method of claim 8 wherein path dimension reduction is realized by multiple paths sharing the same range approximation values.

13. The method of claim 8 wherein the phase shifts are precomputed using all range approximation values before commencing actual measurements.

14. The method of claim 8 wherein phase compensation involves multiplying the measurement signal by the pre-evaluated phase shifts.

15. An MBP method for generating a mm-wave body image, accelerated by an inverse fast Fourier transform (IFFT) along the frequency dimension, comprising:
transmitting a mm-wave signal from a transmitter toward a subject;
receiving the mm-wave signal from the subject using a receiver;
compensating for the phase of a propagation path for all measured frequencies; and
creating an image of the subject by utilizing the phase shifted mm-wave signal.

16. The method of claim 15 wherein the wavenumbers of the frequencies are expressed as a minimum wavenumber plus an integer multiple of an increment.

17. The method of claim 15 wherein the propagation path is expressed as a range base plus multiple increments.

18. The method of claim 15 wherein the phase shift of a measured signal is determined by the minimum path range, wavenumber, and a parameter to regulate the precision of range increments.

19. The method of claim 18 wherein an IFFT is employed on the phase-shifted signal.
